(19) United States
(12) Patent Application Publication
(10) Pub. No.: US 2026/0341864 A1
(43) Pub. Date: Oct. 29, 2026

(54) ELECTRICAL SEALANT FOR BATTERY CELL AND ELECTRICAL SEALANT PROVIDING METHOD

(71) Applicant: Ford Global Technologies, LLC, Dearborn, MI (US)

(72) Inventors: Brian Utley, Canton, MI (US); Yongcai Wang, Ann Arbor, MI (US); Jerry Lan, Ann Arbor, MI (US); Daewon Han, New Hudson, MI (US)

(21) Appl. No.: 19/190,951

(22) Filed: Apr. 28, 2025

(51) Int. Cl. H01M 50/186; F16J 15/02; H01M 50/105; H01M 50/119; H01M 50/121; H01M 50/129; H01M 50/178; H01M 50/198

(52) U.S. Cl. CPC H01M 50/186; F16J 15/022; H01M 50/105; H01M 50/119; H01M 50/121; H01M 50/129; H01M 50/178; H01M 50/198; H01M 2220/20

(57) ABSTRACT

A battery cell assembly includes an electrode structure, a case that houses the electrode structure, and a wet-applied electrical sealant that covers at least a portion of at least one edge of the case. A battery cell electrical sealing method includes applying a liquid to at least one edge of a battery cell, and curing the liquid on the at least one edge to electrically seal the at least one edge.

### TECHNICAL FIELD

This disclosure relates generally to an electrical sealant of a battery cell and, more particularly, to an electrical sealant that is applied as a liquid and cures to cover at least a portion of an edge of a battery cell case.

### BACKGROUND

Electrified vehicles include a traction battery pack for powering electric machines and other electrical loads of the vehicle. The traction battery pack can include a plurality of battery cells and various other battery internal components that support electric vehicle propulsion. The battery cells can include tab terminals secured to busbars, for example. During assembly, the tab terminals can be bent or otherwise manipulated to position the tab terminals for attachment. Some known battery cells include adhesive tape along the edges of the battery cells.

### SUMMARY

In some aspects, the techniques described herein relate to a battery cell assembly, including: an electrode structure; a case that houses the electrode structure; and a wet-applied electrical sealant that covers at least a portion of at least one edge of the case.

In some aspects, the techniques described herein relate to a battery cell assembly, wherein the wet-applied electrical sealant cures to bond to the at least one edge.

In some aspects, the techniques described herein relate to a battery cell assembly, wherein the wet-applied electrical sealant has a cured state where the wet-applied electrical sealant is bonded to the at least one edge.

In some aspects, the techniques described herein relate to a battery cell assembly, further including a tab terminal extending from the electrode structure within the case to an area outside the case, the tab terminal proximate to the at least one edge.

In some aspects, the techniques described herein relate to a battery cell assembly, wherein the wet-applied electrical sealant contacts the tab terminal.

In some aspects, the techniques described herein relate to a battery cell assembly, wherein the wet-applied electrical sealant is a curable sealant.

In some aspects, the techniques described herein relate to a battery cell assembly, wherein the wet-applied electrical sealant is configured to cure to form a barrier over at least a portion of the at least one edge.

In some aspects, the techniques described herein relate to a battery cell assembly, wherein the case includes an aluminum layer sandwiched between first and second polymer-based layers.

In some aspects, the techniques described herein relate to a battery cell assembly, wherein the at least one edge includes at least one cut edge.

In some aspects, the techniques described herein relate to a battery cell assembly, wherein the electrode structure and the case are constituents of a pouch-style battery cell.

In some aspects, the techniques described herein relate to a battery cell assembly, wherein the at least one edge is at least one cut edge.

In some aspects, the techniques described herein relate to a battery cell electrical sealing method, including: applying a liquid to at least one edge of a battery cell; and curing the liquid on the at least one edge to seal the at least one edge.

In some aspects, the techniques described herein relate to a battery cell electrical sealing method, wherein the at least one edge includes at least one cut edge of a case of the battery cell.

In some aspects, the techniques described herein relate to a battery cell electrical sealing method, wherein the battery cell includes at least one tab terminal that extends through the at least one edge from an electrode structure within the case.

In some aspects, the techniques described herein relate to a battery cell electrical sealing method, further including bending the at least one tab terminal after the curing.

In some aspects, the techniques described herein relate to a battery cell electrical sealing method, further including bending the at least one tab terminal by stamping the at least one tab terminal.

In some aspects, the techniques described herein relate to a battery cell electrical sealing method, wherein the applying includes brushing the liquid on to the at least one edge.

In some aspects, the techniques described herein relate to a battery cell electrical sealing method, further including, prior to the applying, cutting a case of the battery cell to establish the at least one edge.

In some aspects, the techniques described herein relate to a battery cell electrical sealing method, wherein the battery cell is a pouch-style cell.

In some aspects, the techniques described herein relate to a battery cell electrical sealing method, wherein the liquid is a liquid electrical isolation tape.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of a battery array from the battery pack of FIG. 1.

FIG. 3 illustrates an expanded view of the battery array of FIG. 2.

FIG. 4 illustrates the battery cell of FIG. 3 within a terminal bending fixture with the wet-applied electrical sealant covering at least one edge of the case according to an exemplary aspect of the present disclosure.

FIG. 5 illustrates an area of FIG. 4 after bending one of the tab terminals.

FIG. 6 illustrates a case for a battery cell in the array of FIG. 3 cut from a sheet of material.

FIG. 7 illustrates the case after being formed to accommodate an electrode structure.

FIG. 8 illustrates the case of FIG. 7 folded over the electrode structure and with tab terminals extending through sides of the case.

FIG. 9 illustrates a closeup view of an area of the battery cell in FIG. 8 showing where one of the tab terminals extends through a side of the battery cell.

FIG. 10 illustrates the area of FIG. 9 as an electrical sealant is applied to at least one edge of the case.

### DETAILED DESCRIPTION

Battery cells can include tab terminals extending from a case. The tab terminals of some battery cells are bent prior to installation within a battery array. Bending the tab terminal can facilitate attachment of the tab terminal to a busbar or other component within the traction battery pack.

This disclosure relates to an electrical sealant that is applied to at least a portion of an edge of the case prior to bending the tab terminal. The electrical sealant can, among other things, interfere with an electrically conductive path between areas of the battery cell fixtures utilized to bend the tab terminal, or both.

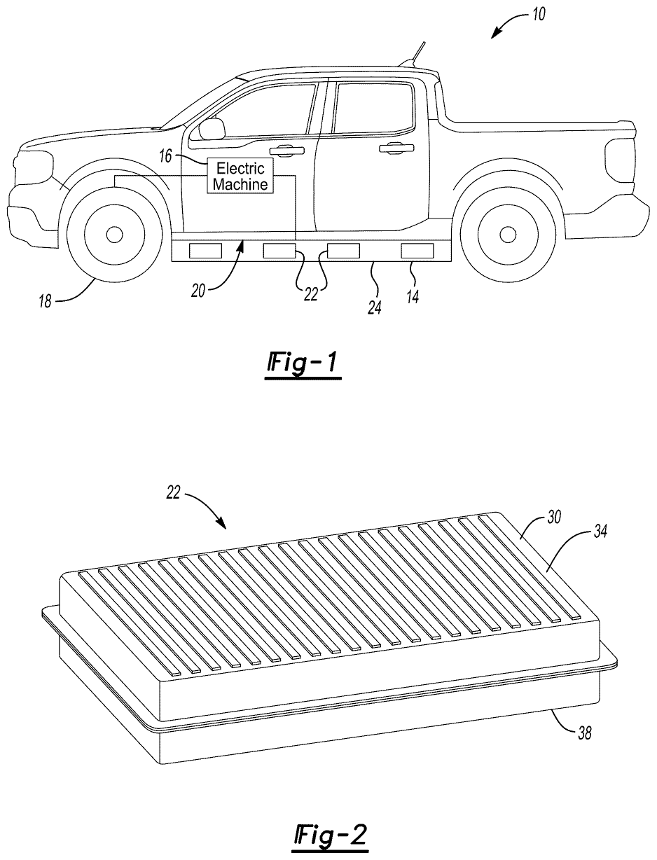

With reference to FIG. 1, an electrified vehicle 10 includes a traction battery pack 14, an electric machine 16, and wheels 18. The traction battery pack 14 powers the electric machine 16, which can convert electrical power to mechanical power to drive the wheels 18. The traction battery pack 14 can be a relatively high-voltage battery.

The traction battery pack 14 is, in the exemplary embodiment, secured to an underbody 20 of the electrified vehicle 10. The traction battery pack 14 could be located elsewhere on the electrified vehicle 10 in other examples. In the exemplary embodiment, the traction battery pack 14 includes one or more battery arrays 22 housed within a pack enclosure 24.

The electrified vehicle 10 is an all-electric vehicle. In other examples, the electrified vehicle 10 is a hybrid electric vehicle, which selectively drives wheels using torque from an internal combustion engine instead of, or in addition to, an electric machine. Generally, the electrified vehicle 10 could be any type of vehicle having a traction battery pack.

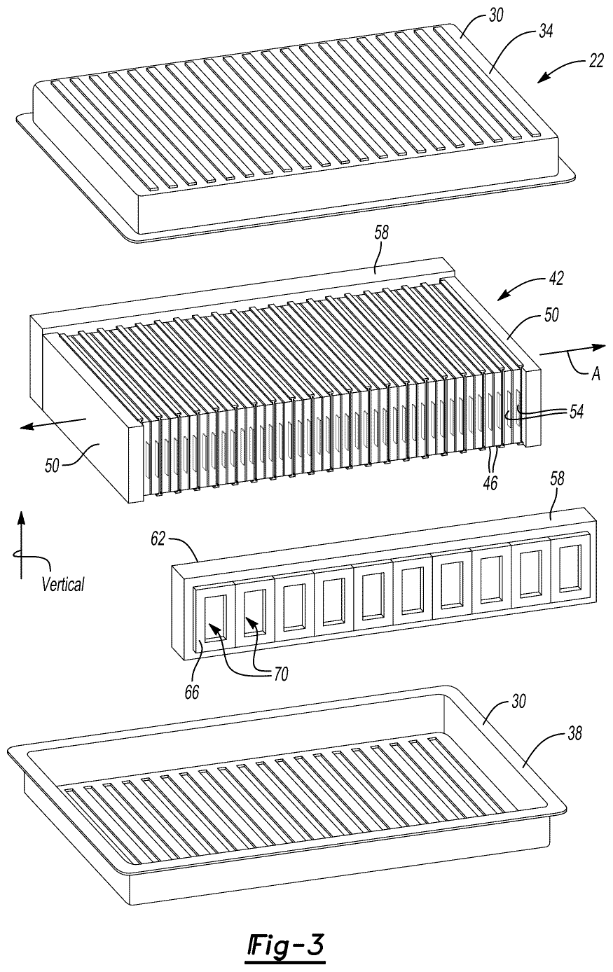

FIGS. 2 and 3 illustrate additional detail of one of the arrays 22 from the traction battery pack 14. In this example, the array 22 includes an array enclosure assembly 30 having enclosure structures—here a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery array 22 in the various drawings and should not otherwise be deemed limiting. These terms are with reference to the general orientation of the battery array 22 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary array enclosure assembly 30 is shown in the drawings, the array enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A. The battery cells 46 can be compressed along the cell stack axis A between a pair of endplates 50.

The cell stack 42 could include any number of battery cells 46. The battery array 22 could be expanded to employ multiple cell stacks 42 within the enclosure assembly 30. Thus, this disclosure is not limited to the exact configuration shown in FIG. 2.

In the exemplary embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

Busbar assemblies 58 are positioned alongside the cell stacks 42. The busbar assemblies 58 include a frame 62 and a plurality of busbars 66 mounted to the frame 62.

The battery cells 46 each include a pair of tab terminals 54 that extend laterally outward from opposing sides of each of the battery cells 46. The tab terminals 54 can extend through apertures 70 within the busbars 66 and the frame 62. The tab terminals 54 can be folded over the busbars 66 and secured directly to the busbars 68 to electrically couple the battery cells 46 to each other, to other components, etc. The tab terminals 54 can be secured directly to the busbars 68 via one or more welds.

In the exemplary embodiment, the tab terminals 54 are bent prior to attachment to the busbars 66. Bending the tab terminals 54 can facilitate attachment of the tab terminals 54 to the busbars 66. In some examples, the tab terminals 54 can be instead or additionally trimmed prior to installation and attachment to the busbars 66.

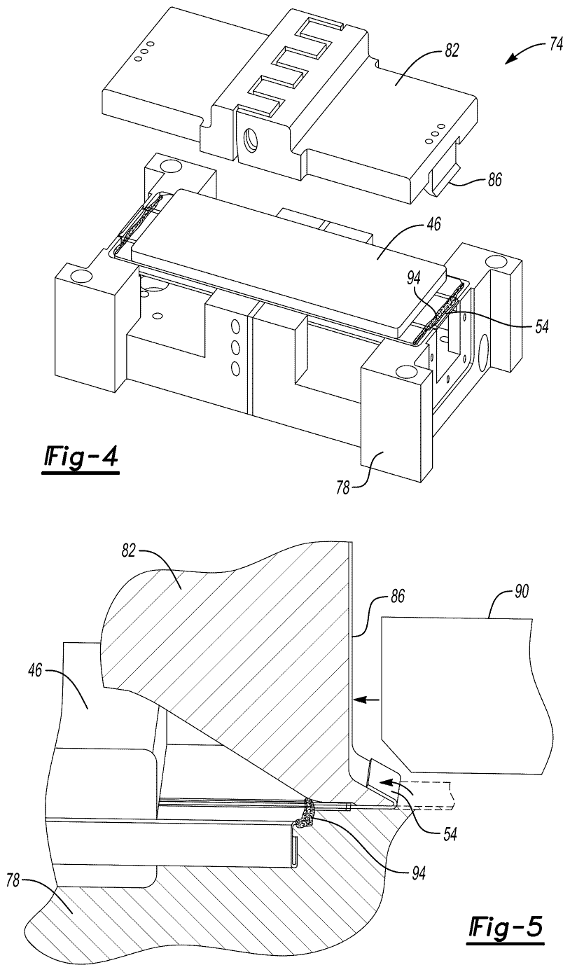

With reference now to FIGS. 4 and 5, and continuing reference to FIG. 3, during assembly, each of the battery cells 46 is positioned within a bending tool 74 that is actuated to bend the tab terminals 54 into a position appropriate for installation into the battery array 22.

In the exemplary embodiment, the bending tool 74 includes a lower tool 78 and an upper tool 82 having a bending flange 86 associated with each of the tab terminals 54.

To bend the tab terminals 54 of one of the battery cells 46, the battery cell 46 is loaded into the lower tool 78 or nest. The upper tool 82 is then pressed downward driving the bending flange 86 into an associated one of the tab terminals 54.

A slider 90 of the bending tool 74 can then be moved inward toward the bending flange 86 to fold the tab terminal 54 over the bending flange 86 as shown in FIG. 5. The upper tool 82 can then be withdrawn and the battery cell 46 removed from the lower tool 78 for installation into the battery array 22 with the tab terminals 54 of that battery cell 46 bent into a position appropriate for attachment to the busbars 66. The bending tool 74 can include areas that are electrically isolated from each other. For example, different portions of the lower tool 78 can be electrically isolated from each other.

In the exemplary embodiment, the battery cell 46 includes an electrical sealant 94 that helps to inhibit creation of an electrically conductive path between the terminal 54 and other areas of the battery cell 46, during the bending of the terminal 54.

With reference now to FIGS. 6-10, and continuing reference to FIGS. 3-5, the battery cells 46 include a case 100 that is folded over an electrode structure 104 and sealed when assembling the battery cell 46. The case 100 is formed from a sheet of material 108 that is cut from a larger sheet of material as shown in FIG. 6. Around a periphery of the case 100 are cut edges 112.

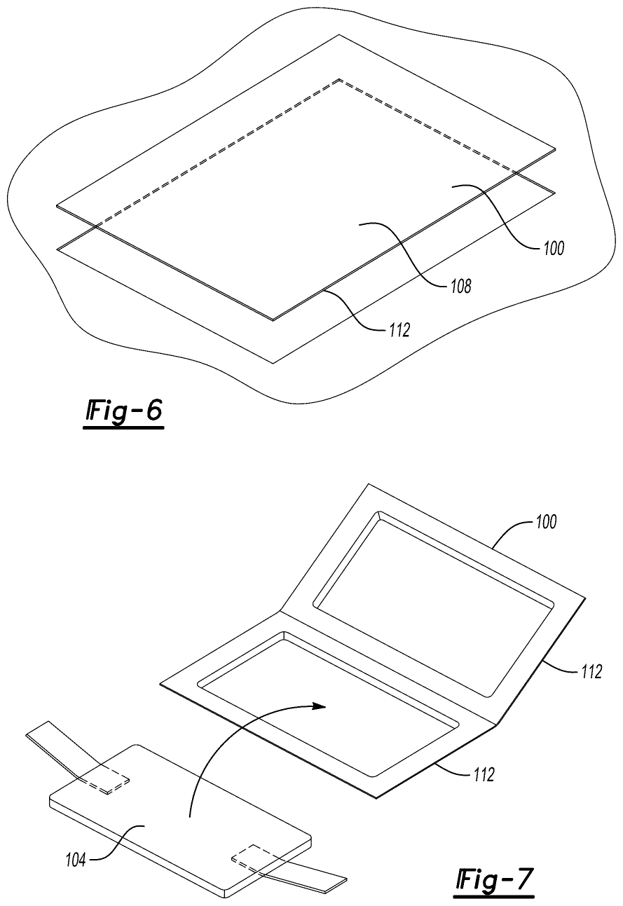

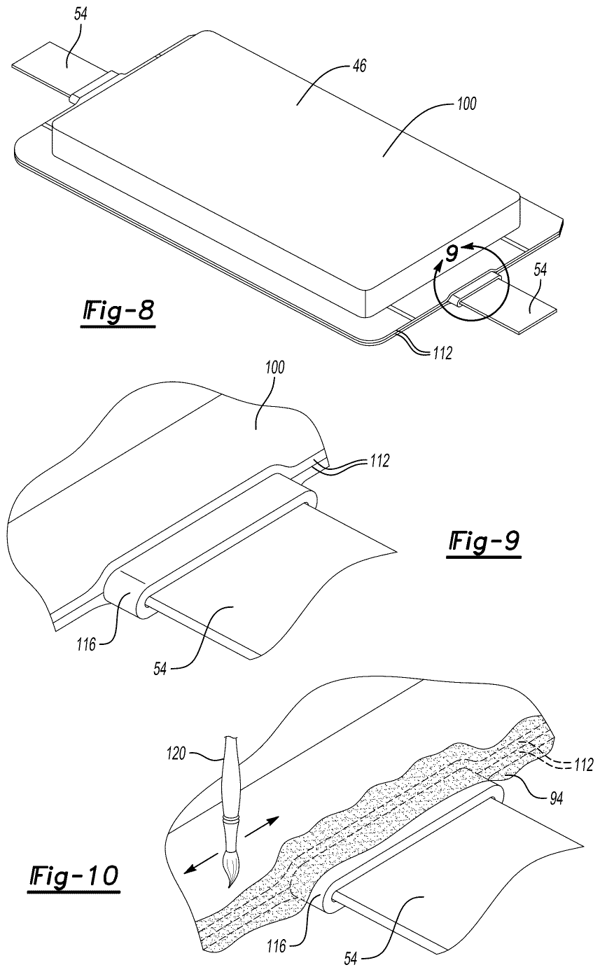

The tab terminals 54 extend outward from within the case 100 to an area outside the case 100. When the case 100 is formed into a clamshell shape and then folded over the electrode structure 104 as shown in FIGS. 7 and 8, the tab terminals 54 extend out from within the case 100 between cut edges 112 of the case 100.

The case 100 can include an aluminum layer sandwiched between two polymer-based layers. The aluminum layer can be exposed at the cut edges 112 after being cut from the sheet of material 108. The aluminum layer can be incorporated into the case 100 as a water vapor barrier.

An insulative sleeve 116 can surround the tab terminal 54 where the tab terminal 54 exits from within the case 100. The insulative sleeve 116 keeps the tab terminal 54 from contacting the case 100.

After folding the case 100 and sealing the electrode structure 104 within the case 100, the example battery cell 46 has the electrical sealant 94 applied to at least areas of the edges 112 proximate the terminal 54 as shown in FIG. 10.

The example electrical sealant 94 is a wet-applied electrical sealant. The example electrical sealant 94 is applied as a liquid and then cures to bond to the cut edges 112 of the case 100 and other structures. The electrical sealant 94 can thus be characterized as a curable sealant. In some examples, the electrical sealant 94 is a liquid electrical isolation tape. The electrical sealant 94 being wet-applied is structurally distinguishable from other types of barriers, such as tapes that are adhesively secured.

An operator can apply the electrical sealant 94 using a brush 120. The electrical sealant 94 can cover all the cut edges 112 or only portions of the cut edges 112, such as portions that are proximate to the tab terminals 54.

After the wet-applied electrical sealant 94 is applied, the electrical sealant 94 cures and bonds to the cut edges 112 as the electrical sealant 94 cures. After curing, the electrical sealant 94 can be said to be in a cured state where the electrical sealant 94 is bonded to the edges 112.

In addition to portions of the cut edges 112, the electrical sealant 94 in some examples additionally covers areas of the insulative sleeve 116 and the tab terminal 54. The electrical sealant 94, after curing, forms a barrier between at least some of the cut edges 112 of the case 100 and other structures.

When the bending tool 74 is utilized to bend the tab terminals 54, the electrical sealant 94 blocks the bending flange 86 from creating a conductive path between the tab terminal 54 and other areas of the battery cell 46 or the bending tool 74, such as between the tab terminal 54 and the aluminum layer of the case 100.

Features of the disclosed examples include applying a curable electrical sealant to a cut edge of a battery cell case. The sealant covers the cut edge. Application of the curable electrical sealant can automated in a relatively straightforward way.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery cell assembly, comprising:
an electrode structure;
a case that houses the electrode structure; and
a wet-applied electrical sealant that covers at least a portion of at least one edge of the case.

2. The battery cell assembly of claim 1, wherein the wet-applied electrical sealant cures to bond to the at least one edge.

3. The battery cell assembly of claim 1, wherein the wet-applied electrical sealant has a cured state where the wet-applied electrical sealant is bonded to the at least one edge.

4. The battery cell assembly of claim 1, further comprising a tab terminal extending from the electrode structure within the case to an area outside the case, the tab terminal proximate to the at least one edge.

5. The battery cell assembly of claim 4, wherein the wet-applied electrical sealant contacts the tab terminal.

6. The battery cell assembly of claim 1, wherein the wet-applied electrical sealant is a curable sealant.

7. The battery cell assembly of claim 1, wherein the wet-applied electrical sealant is configured to cure to form a barrier over at least a portion of the at least one edge.

8. The battery cell assembly of claim 1, wherein the case includes an aluminum layer sandwiched between first and second polymer-based layers.

9. The battery cell assembly of claim 1, wherein the at least one edge comprises at least one cut edge.

10. The battery cell assembly of claim 1, wherein the electrode structure and the case are constituents of a pouch-style battery cell.

11. The battery cell assembly of claim 1, wherein the at least one edge is at least one cut edge.

12. A battery cell electrical sealing method, comprising:
applying a liquid to at least one edge of a battery cell; and
curing the liquid on the at least one edge to electrically seal the at least one edge.

13. The battery cell electrical sealing method of claim 12, wherein the at least one edge comprises at least one cut edge of a case of the battery cell.

14. The battery cell electrical sealing method of claim 13, wherein the battery cell includes at least one tab terminal that extends through the at least one edge from an electrode structure within the case.

15. The battery cell electrical sealing method of claim 14, further comprising bending the at least one tab terminal after the curing.

16. The battery cell electrical sealing method of claim 15, further comprising bending the at least one tab terminal by stamping the at least one tab terminal.

17. The battery cell electrical sealing method of claim 12, wherein the applying comprises brushing the liquid on to the at least one edge.

18. The battery cell electrical sealing method of claim 12, further comprising, prior to the applying, cutting a case of the battery cell to establish the at least one edge.

19. The battery cell electrical sealing method of claim 12, wherein the battery cell is a pouch-style cell.

20. The battery cell electrical sealing method of claim 12, wherein the liquid is a liquid electrical isolation tape.
